(19) United States
(12) Patent Application Publication
(10) Pub. No.: US 2012/0207961 A1
(43) Pub. Date: Aug. 16, 2012

(54) FIRE PROTECTION ELEMENT

(75) Inventors: Michael DREXL, Schondorf (DE); Manfred Klein, Kaufering (DE)

(73) Assignee: Hilti Aktiengesellschaft, Schaan (LI)

(21) Appl. No.: 13/300,321

(22) Filed: Nov. 18, 2011

(30) Foreign Application Priority Data
Nov. 19, 2010 (DE) 10 2010 044 161.9

(51) Int. Cl. E04B 1/94; B32B 17/04; B32B 5/28

(52) U.S. Cl. 428/64.1; 442/136; 428/76; 442/1; 428/175; 442/138

(57) ABSTRACT

A fire protection element is disclosed. The fire protection element has a foamed body formed at least partially of an ash-forming mixture, and in an embodiment, an intumescent mixture. A carrier component is embedded in the foamed body. The carrier component is a thin, flat part which is covered by the body on at least one flat side.

This application claims the priority of German Patent Document No. 10 2010 044 161.9, filed Nov. 19, 2010, the disclosure of which is expressly incorporated by reference herein.

### BACKGROUND AND SUMMARY OF THE INVENTION

The invention relates to a fire protection element having a foamed body, which is made at least partially of an ash-forming and, if applicable, intumescent mixture.

Fire protection elements made of foamed material with intumescent additives are used, for example, to seal cable and pipe lead-throughs so they are flue-gas-proof as well as heat and fire-resistant. The foamed material in this case serves as a matrix for fire-protection additives. Fire protection elements with a rectangular block shape are used for bulkheading large lead-throughs. In this case, the fire protection elements are made of a polymer matrix into which various additives such as intumescent materials, ash-crust formers and ash-crust stabilizers are introduced.

Their heat and fire-resistant properties are produced in the event of a fire in that the fire protection element burns away on the outside and forms a layer of ash. This layer of ash then provides thermal insulation. What is important, however, in this case is that the layer of ash is as stable as possible so that it does not fall off from the rest of the fire protection element. This is achieved, for example, by chemical additives in the foamed material. In the case of large fire protection elements or large lead-throughs that need to be sealed, adequate mechanical stability of the ash crust itself as well as sufficiently stable adherence of the ash crust to the still unburned portion of the fire protection element must naturally be preserved even when there is advanced fire development.

In the case of larger fire protection elements, such as fire protection blocks, it is frequently observed that when there is advanced burn-off of the fire-protection block, the ash that has already formed falls off or the still unburned portion of the fire-protection block falls out of the bulkhead. This can be attributed for one to the matrix beginning to melt in the case of a fire whereby the intumescence of the additives is initially able to take place. However, the zone of the liquid matrix weakens the bond with the already formed ash crust. In addition, the intumescence may contribute to the still unburned portion of the fire-protection block being pushed out of the bulkhead. This may become problematic particularly in the case of large ceiling bulkheads.

The weakening of the bond between the ash crust and the still unburned portion of the fire-protection block can become a problem in the case of the hose stream test required in the U.S., in which the crust must be able to withstand a strong water stream after the fire.

Consequently, attempts were made to strengthen the bond between the ash crust and the unburned portion of the fire protection element. For this purpose, applying a wire mesh on the outside of the fire protection element or attaching the fire protection element to a wire mesh are known, which prevents the layer of ash from falling off. This is especially important in the case of so-called ceiling bulkheads so that the ash does not detach from the substrate and fall off the bulkhead in thick layers. Then the underlying layer would namely be burned, which would reduce the mechanical strength of the fire protection element as well as its resistance time against burn-through. Crossbars, intermediate layers made of glass-fiber fabric or the like, which close the fire protection element at the bottom, are also known.

The object of the invention is improving a fire protection element such that the ash crust originating in the event of a fire is kept on the fire protection element in the most stable manner possible.

The fire protection element of the type cited at the outset according to the invention features at least one carrier component, which is designed as a thin, flat part. In particular, the carrier component is a prefabricated carrier component embedded in the body, which is covered by the body on one of its two flat sides, preferably completely covered.

The fire protection element is not defined as a specific form. According to the invention, the component may assume any imaginable form which is used for bulkhead lead-throughs for the purpose of fire protection. Forms that are a possibility for this are stones in the form of bricks, mats, plugs for sealing round openings, wall lead-throughs for individual cables (bushings) just to name a few as examples.

In one embodiment of the invention, the carrier component is fastened subsequently to the fire protection element. It may be affixed to the fire protection element in a manner known to a person skilled in the art so that the carrier component is covered on one side by the body of the fire protection element.

In a preferred embodiment, the fire protection element according to the invention does not provide any carrier components or auxiliary means such as wire mesh, supports or glass-fiber fabric that are subsequently attached on the outside. Rather the stability of the ash crust is achieved by a carrier component embedded in the body, preferably one that is completely embedded. This embodiment relates to a fire protection element having a foamed body, which is made at least partially of an ash-forming and, if applicable, intumescent mixture, and at least one prefabricated carrier component embedded in the body, wherein the carrier component is a thin, flat part, which is covered by the body on at least one flat side, preferably on three sides, especially preferably completely.

This carrier component is not a thick, voluminous component, but a flat part whose thickness is preferably a maximum of 2 mm. This thickness is measured perpendicular to the main extension direction of the part. This carrier component also differs in this respect from the honeycomb-shaped component which is provided for in German Patent Document No. DE 10 2005 013 724 B4. The fire protection element according to the invention is very easy to produce in contrast to it; in particular, the formation of large bubbles in the body from numerous to-be-filled chambers that are separated from each other by bulkheads is ruled out because of the thin, flat geometry of the carrier component.

The flat part may also be formed by placing fibers or fibrous elements, which are not connected to one another, adjacent to one another. In this case, it is important for the threads to be integrated therein in the direction of the burning away of the component, because otherwise the effect according to the invention will not be achieved.

So that in the event of fire the carrier component has the best possible connection between the already formed (intumescent) ash crust and the still unburned portion of the fire protection element, it should be covered by the body on at least three sides, preferably on all sides. This means that the carrier component may form an outer side of the fire protection element. The carrier component preferably does not extend up to the outer side of the body.

The carrier component may be a flexible part in particular, which is preferably designed not to be rigid, but imparts the fire protection element with stability once it is embedded in the body during foaming.

The carrier component has a structure which ensures a connection between the ash crust and the still unburned portion of the component beyond the melting zone. As already explained above, this may be achieved by fibers or threads arranged side-by-side such as a mat. According to the preferred embodiment, the carrier component has a grid structure through which the foam extends.

A fabric is preferably used as the carrier component.

It is also important in the case of the fire protection element according to the invention that, according to one embodiment, the carrier component has a mesh size and the threads of the fabric have a thread size, which are in a specific ratio to each other. The thread size in this case does not relate to the size of an individual thread, but to the thickness of the fabric. The ratio of the mesh size to the thread size should be in the range of 1 to 200, in particular in the range of 12 to 18.

The threads of the fabric may have a thread size between 0.05 and 1 mm, preferably between 0.1 and 0.8 mm and especially preferably 0.2 mm, and/or the fabric has a mesh size of 1 to 50 mm, preferably 2 to 20 mm and especially preferably 3 to 5 mm.

According to the preferred embodiment, the carrier component is made of a temperature-resistant material, in particular an inorganic material. Temperature-resistant within the scope of the invention means that the materials have a higher melting point than the matrix material. Such materials may be carbon, ceramic, basalt, mineral fibers, glass fibers, natural fibers and composites with plastics. Even perforated sheeting, expanded metals, fabric made of metals such as aluminum, which are created in such a way that they do not impair the flexible properties of the fire protection element, may be used as the carrier component according to the invention.

It is preferred that such materials be used as the carrier component, which permit a simple processing, such as cutting the fire protection element to size with a carpet knife.

Though fireproof carrier components are preferred, depending upon the thickness of the layer between the outer side of the fire protection element and the carrier component, even combustible materials may be used for the carrier component. In this case, the only thing that must be ensured is that the layer of ash that develops in the event of fire is designed to be thick enough.

For clarification purposes, the invention will be described more precisely on the basis of a fire-protection block without restricting the invention to a fire-protection block.

The arrangement of the component in the fire protection element is not limited as long as the carrier component is embedded in the direction of the burning of the fire protection element. In one embodiment of the invention, the carrier component may be arranged as close as possible to the outer side of the fire protection element. In particular, it may extend in this case along at least one outer side of the body. In the case of a fire protection element in the shape of a rectangular solid for example, which is installed in a lead-through in such a way that its longer side extends into the lead-through so that the burning takes place starting from the smaller side surface of the rectangular solid, the carrier component should extend at least along the base surface of the rectangular solid.

One possible embodiment in this case provides that the carrier component extends completely along an outer side, preferably along several outer sides of the body.

Alternatively or additionally, a component that is embedded in the carrier component in a bent or kinked manner may be provided. For example, the carrier component may run in a wavy manner or be bent in a V-shaped manner. In addition, overlapping or intersecting carrier components may also be used.

As already explained, the fire protection element according to a preferred embodiment has the shape of a rectangular solid.

Additional features and advantages of the invention are disclosed in the following description and the following drawings to which reference is made.

### BRIEF DESCRIPTION OF THE DRAWINGS

FIG. 1 shows a perspective view of a carrier component used with a fire protection element according to the invention along with a mold for producing the fire protection element according to the invention as well as the fire protection element according to the invention that was produced therewith.

FIGS. 2 to 4 show various embodiments of carrier components, which are embedded in the fire protection element according to the invention.

### DETAILED DESCRIPTION OF THE DRAWINGS

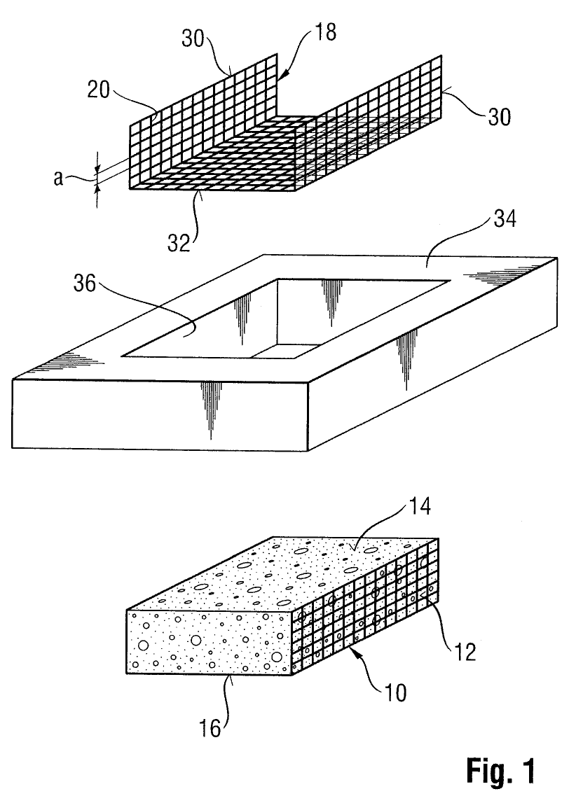

FIG. 1 shows a fire protection element 10 which is used, for example, in ceiling openings to seal cable and/or pipe lead-throughs.

The fire protection element 10 has a rectangular block-shaped body having several outer sides, more precisely, side surfaces 12 as well as an upper side and a lower side 14 or 16.

The fire protection element 10 is made in part of an ash-forming and, if applicable, intumescent mixture, which is added to a foaming substance. This mixture together with the foaming substance, preferably polyurethane, produces a foamed body after foaming and hardening. One or more carrier components 18 are embedded in this foamed body. FIG. 1 depicts a carrier component 18 which has a U-shape.

A very thin, preferably flat, prefabricated component is used as the carrier component. A commercially available reinforcement fabric made of textile glass material is preferably used.

According to preferred embodiment, the carrier component is designed to be flexible, in particular not inherently rigid.

One example of such a carrier component is a fabric having several threads 20 which have a thickness of between 0.1 and 1 mm, preferably 0.2 to 0.3 mm.

The carrier component 18 has numerous openings, the size of which is defined by a so-called mesh size. The mesh size is between 1 and 50 mm, preferably 3.5 to 4.5 mm. The mesh size is defined as the smallest distance between adjacent grid elements (threads in the case of fabric). The mesh size is designated as “a” in FIG. 1.

The mesh size a is proportional to the thread size, and specifically its ratio is 1 to 200, in particular 10 to 50 and especially preferably 12 to 18.

Inorganic and/or organic materials or even combustible materials are used as the material for the carrier component. Materials like carbon, ceramic, basalt, mineral fibers, glass fibers, natural fibers and composites with plastic in use as well as pure plastics which have a higher melting point than the matrix material are preferred.

The carrier component 18 is so thin and flexible that it may be cut with a knife, in particular a type of carpet knife or with a pair of scissors. Ideally, the carrier component is produced from a glass-fiber material, wherein metal may also be used however.

The production of the fire protection element will be explained in the following.

The carrier component 18 is cut and then bent into a U-shape in the following case.

In the case of the depicted embodiment, two sides 30 as well as a base surface 32 are provided, which are assigned to two side surfaces 12 as well as the lower side 16.

The carrier component 18 is inserted into a mold part 34, which has a surrounding frame as well as a base. The size of the carrier component 18 is selected such that the surfaces 30 and 32 are somewhat smaller than the associated surfaces in the recess of the mold part. After putting the carrier component 18 into the recess 36 in the mold part 34, the carrier component 18 is positioned in such a way that it is at a short distance from the mold part 34 on all sides.

Then a flowable mixture is poured into the recess 36, wherein possibly even beforehand, prior to inserting the carrier component 18, a portion of this mass could be introduced in the region of the base of the mold part 34. Finally, the mold part is closed on the upper side by a cover (not shown). The introduced mass is, for example, polyurethane with an ash-forming and, if applicable, intumescent mixture. The mass foams up and penetrates the carrier component 18 because of the numerous openings. After hardening, the carrier component 18 is preferably completely inside the formed, foamed body. To simplify the fabrication of the fire protection element 10, the surface 32 may also form a base surface of the fire protection element 10. The carrier component 18 together with the foamed body forms the fire protection element 10. Due to the grid structure, the ash crust holds very stably in the event of fire to the rest of the fire protection element. In addition, the entire fire protection element 10 is imparted with a greater mechanical strength.

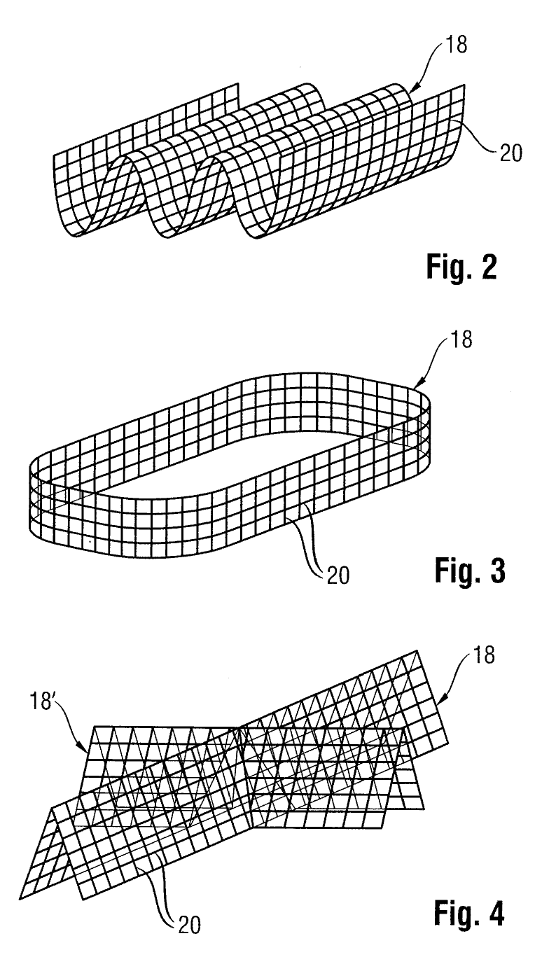

FIG. 2 shows another embodiment of the carrier component 18, which is designed to be wavy in this case and this wave shape is accommodated completely in the foamed body. This wave shape, which may be accommodated transversely or longitudinally in the foamed body, provides very stable support for the carrier component in the body, which is also beneficial for supporting the ash crust. Namely, if the ash crust falls away partially so that the carrier component is exposed or subjected to too much thermal stress, the entire carrier component does not fall off or burn off abruptly, but only a portion thereof. The remaining part continues to be available as a support via the new crust that then forms.

An annular carrier component 18 is used in FIG. 3, which runs near to the outer sides 12. In this case, a carrier component is not provided in the region of the upper or lower side 14 or 16. The threads of this grid structure as well may be aligned in a different manner; they do not have to extend parallel to the main extension direction (circular direction). Incidentally, this also applies to the embodiment according to FIG. 2, in which similarly a grid structure, preferably also a fabric, is provided. By the way, also applicable to all embodiments is that the properties of the carrier component mentioned above in conjunction with FIG. 1 may also be present here.

In the case of the embodiment according to FIG. 4, several carrier components 18, 18′ are provided, and namely in the form of carrier components running kinked or bent in a V-shaped manner, which are partially slotted so that they may be inserted into one another. This produces a type of cross structure. In this case as well, just like with the other embodiments, the carrier component 18, 18′ is completely accommodated in the foamed body.

Although we previously spoke of non-rigid carrier components, of course, rigid carrier components may also be used, which improves positioning thereof when introducing the flowing mass and with subsequent foaming.

One example of such a rigid design would be to provide the carrier component with an additional structure or an additional supporting substance, for example, in that the previously flexible carrier component is shaped and then brought to a permanent shape via metal supports or plastic sheathing.

In the event of fire, the carrier component for one acts as a reinforcement by making the layer of ash more stable on the one hand, i.e., by strengthening the bond between the layer of ash and the unburned portion of the fire protection element so that the fire protection element withstands stress such as, for example, in the so-called hose stream test (in accordance with the ASTM test standard). On the other hand, the carrier component makes sure that the intumescence does not take place in an unrestrained and undirected manner, but a compression and therefore a greater stability of the layer of ash are achieved by the diminished intumescence. In addition, when using the fire protection element as a ceiling bulkhead, the carrier component prevents the layer of ash from falling off, whereby the fire element remains stable for a longer time.

Additional auxiliary means for external support of the fire protection element are not provided. As a result, the production and installation of the fire protection element are simplified.

It is preferred that no additional top layers or the like be affixed on the outer side of the fire protection element.

The flat sides of the thin, flat carrier component 18 are the sides of the largest surfaces; in terms of FIG. 1 the upper and lower sides for the section 32, and in terms of section 30 the inner and outer sides.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A fire protection element, comprising:
a foamed body formed at least partially of an ash-forming mixture; and
a carrier component, wherein the carrier component is comprised of a thin, flat part and wherein the carrier component is embedded in the foamed body.

2. The fire protection element according to claim 1, wherein the foamed body is additionally formed of an intumescent mixture.

3. The fire protection element according to claim 1, wherein the carrier component is completely embedded in the foamed body.

4. The fire protection element according to claim 1, wherein the carrier component is flexible.

5. The fire protection element according to claim 1, wherein the carrier component has a grid structure.

6. The fire protection element according to claim 1, wherein the carrier component is a fabric or a mat.

7. The fire protection element according to claim 6, wherein the carrier component has a mesh size, wherein threads of the fabric have a thread size, and wherein a ratio of the mesh size to the thread size is in a range of 1 to 200.

8. The fire protection element according to claim 7, wherein the threads of the fabric have a thread size which is in a range of 0.05 to 1 mm and/or the fabric has a mesh size in a range between 1 and 50 mm.

9. The fire protection element according to claim 1, wherein the carrier component is formed of a temperature-resistant material.

10. The fire protection element according to claim 9, wherein the carrier component is formed of glass fibers.

11. The fire protection element according to claim 1, wherein the carrier component is embedded in the foamed body in a bent or kinked configuration.

12. The fire protection element according to claim 10, wherein the carrier component extends to near an outer surface of the foamed body.

13. The fire protection element according to claim 1, wherein the carrier component is embedded in the foamed body in a wavy, an annular, or a U-shaped configuration.

14. The fire protection element according to claim 1, wherein the fire protection element has a shape of a rectangular solid.

15. The fire protection element according to claim 1, wherein the fire protection element is cylindrical or conical in shape.

16. The fire protection element according to claim 1, wherein the carrier component is formed into a shape.
